(19) United States
(12) Patent Application Publication
(10) Pub. No.: US 2014/0154075 A1
(43) Pub. Date: Jun. 5, 2014

(54) POWER PRODUCTION OF WIND TURBINES

(71) Applicants: Jacob Krogh Kristoffersen, Viby J (DK); Jesper Sandberg Thomsen, Hadsten (DK)

(72) Inventors: Jacob Krogh Kristoffersen, Viby J (DK); Jesper Sandberg Thomsen, Hadsten (DK)

(73) Assignee: VESTAS WIND SYSTEMS A/S, Aarhus N (DK)

(21) Appl. No.: 14/130,421

(22) PCT Filed: Jun. 29, 2012
(86) PCT No.: PCT/DK2012/050220

§ 371 Date: Jan. 26, 2014

Related U.S. Application Data
(60) Provisional application No. 61/506,172, filed on Jul. 11, 2011.

(30) Foreign Application Priority Data
Jul. 8, 2011 (DK) PA 2011 00521

(51) Int. Cl. F03D 7/02

(52) U.S. Cl. CPC F03D 7/0224
USPC 416/1; 416/147; 416/31

(57) ABSTRACT

Embodiments of the invention generally relate to wind turbine generators, and more specifically to improving power production in wind turbine generators. A rotor plane of the wind turbine may be divided into a plurality of sections. A characteristic of wind associated with each section may be determined. An optimal pitch angle may be determined for each section based on the associated wind characteristic. A pitch controller may adjust the pitch angle of a blade to the optimal pitch angle as the blade sweeps through the section.

### FIELD OF THE INVENTION

Embodiments of the invention generally relate to wind turbine generators, and more specifically to improving power production in wind turbine generators.

### BACKGROUND

In recent years, there has been an increased focus on reducing emissions of greenhouse gases generated by burning fossil fuels. One solution for reducing greenhouse gas emissions is developing renewable sources of energy. Particularly, energy derived from the wind has proven to be an environmentally safe and reliable source of energy, which can reduce dependence on fossil fuels.

Energy in wind can be captured by a wind turbine, which is a rotating machine that converts the kinetic energy of the wind into mechanical energy, and the mechanical energy subsequently into electrical power. Common horizontal-axis wind turbines include a tower, a nacelle located at the apex of the tower, and a rotor that is supported in the nacelle by means of a shaft. The shaft couples the rotor either directly or indirectly with a rotor assembly of a generator housed inside the nacelle. A plurality of wind turbines generators may be arranged together in a wind park or wind power plant to generate sufficient energy to support a grid.

Most modern wind turbines include a pitching system capable of adjusting a pitch angle of the wind turbine blades. By pitching the blades into or out of the wind, the rotation of the wind turbine, and therefore the power production of the wind turbine, may be controlled.

### SUMMARY OF THE INVENTION

Embodiments of the invention generally relate to wind turbine generators, and more specifically to improving power production in wind turbine generators.

One embodiment of the invention provides a method for improving power production of a wind turbine. The method generally comprises dividing a rotor plane into a plurality of sections, and for each section, determining a characteristic of wind associated with the section. The method further comprises, for each section, determining an optimal pitch angle based on the determined characteristic of wind of the section, and adjusting a pitch angle of a blade of the wind turbine to the optimal pitch angle of each section as the blade sweeps through the section.

Another embodiment of the invention provides a pitch controller of a wind turbine. The pitch controller is generally configured to divide a rotor plane into a plurality of sections, and for each section, determine a characteristic of wind associated with the section. The pitch controller is further configured to, for each section, determine an optimal pitch angle based on the determined characteristic of wind of the section, and adjust a pitch angle of a blade of the wind turbine to the optimal pitch angle of each section as the blade sweeps through the section.

Yet another embodiment of the invention provides a wind turbine generally comprising a rotor, wherein the rotor plane is divided into a plurality of predefined sections, an azimuth angle sensor configured to determine a position of each blade in the rotor plane, and a pitch controller. The pitch controller is generally configured to divide a rotor plane into a plurality of sections, and for each section, determine a characteristic of wind associated with the section. The pitch controller is further configured to, for each section, determine an optimal pitch angle based on the determined characteristic of wind of the section, and adjust a pitch angle of a blade of the wind turbine to the optimal pitch angle of each section as the blade sweeps through the section.

### BRIEF DESCRIPTION OF THE DRAWINGS

Embodiments of the present invention are explained, by way of example, and with reference to the accompanying drawings. It is to be noted that the appended drawings illustrate only examples of embodiments of this invention and are therefore not to be considered limiting of its scope, for the invention may admit to other equally effective embodiments.

FIG. 1 illustrates an exemplary wind turbine according to an embodiment of the invention.

FIG. 2 illustrates and exemplary wind turbine nacelle according to an embodiment of the invention.

FIG. 3 illustrates an exemplary control system for a wind turbine, according to an embodiment of the invention.

FIG. 4 illustrates an exemplary rotor plane according to an embodiment of the invention.

FIG. 5 is a flow diagram of exemplary operations performed by a pitch controller, according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention.

Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

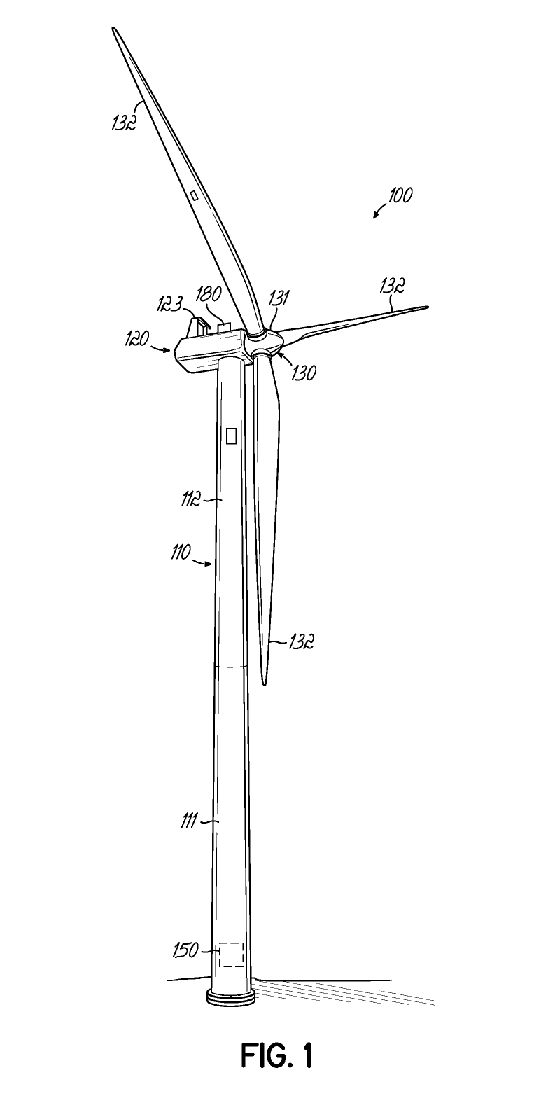

FIG. 1 illustrates an exemplary wind turbine 100 according to an embodiment of the invention. As illustrated in FIG. 1, the wind turbine 100 includes a tower 110, a nacelle 120, and a rotor 130. In one embodiment of the invention, the wind turbine 100 may be an onshore wind turbine. However, embodiments of the invention are not limited only to onshore wind turbines. In alternative embodiments, the wind turbine 100 may be an off shore wind turbine located over a water body such as, for example, a lake, an ocean, or the like.

The tower 110 of wind turbine 100 may be configured to raise the nacelle 120 and the rotor 130 to a height where strong, less turbulent, and generally unobstructed flow of air may be received by the rotor 130. The height of the tower 110 may be any reasonable height. The tower 110 may be made from any type of material, for example, steel, concrete, or the like. In some embodiments the tower 110 may be made from a monolithic material. However, in alternative embodiments, the tower 110 may include a plurality of sections, for example, two or more tubular steel sections 111 and 112, as illustrated in FIG. 1. In some embodiments of the invention, the tower 110 may be a lattice tower. Accordingly, the tower 110 may include welded steel profiles.

The rotor 130 may include a rotor hub (hereinafter referred to simply as the “hub”) 131 and at least one blade 132 (three such blades 132 are shown in FIG. 1). The rotor hub 131 may be configured to couple the at least one blade 132 to a shaft (not shown). In one embodiment, the blades 132 may have an aerodynamic profile such that, at predefined wind speeds, the blades 132 experience lift, thereby causing the blades to radially rotate around the hub. The nacelle 120 may include one or more components configured to convert aero-mechanical energy of the blades to rotational energy of the shaft, and the rotational energy of the shaft into electrical energy.

FIG. 1 also depicts a wind sensor 123. Wind sensor 123 may be configured to detect a direction of the wind at or near the wind turbine 100. By detecting the direction of the wind, the wind sensor 123 may provide useful data that may determine operations to yaw the wind turbine 100 into the wind. The wind sensor 123 may use the speed and/or direction of the wind to control the blade pitch angle. Wind speed data may be used to determine an appropriate pitch angle that allows the blades 132 to capture a desired amount of energy from the wind or to avoid excessive loads on turbine components. In some embodiments, the wind sensor 123 may be integrated with a temperature sensor, pressure sensor, and the like, which may provide additional data regarding the environment surrounding the wind turbine. Such data may be used to determine one or more operational parameters of the wind turbine to facilitate capturing of a desired amount of energy by the wind turbine 100 or to avoid damage to components of the wind turbine.

In one embodiment of the invention, a light detection and ranging (LIDAR) device 180 may be provided on or near the wind turbine 100. For example, the LIDAR 180 may be placed on a nacelle, hub, and/or tower of the wind turbine. In FIG. 1, the LIDAR 180 is shown placed on the nacelle 120. In alternative embodiments, the LIDAR 180 may be placed in one or more blades 132 of the wind turbine 100. In some other embodiments, the LIDAR device may be placed near the wind turbine 100, for example, on the ground. In general, the LIDAR 180 may be configured to detect wind speed and/or direction at one or more points in front of the wind turbine 100. In other words, the LIDAR 180 may allow the wind turbine to detect wind speed before the wind actually reaches the wind turbine. This may allow wind turbine 100 to proactively adjust one or more of blade pitch angle, generator torque, yaw position, and like operational parameters to capture greater energy from the wind, reduce loads on turbine components, and the like.

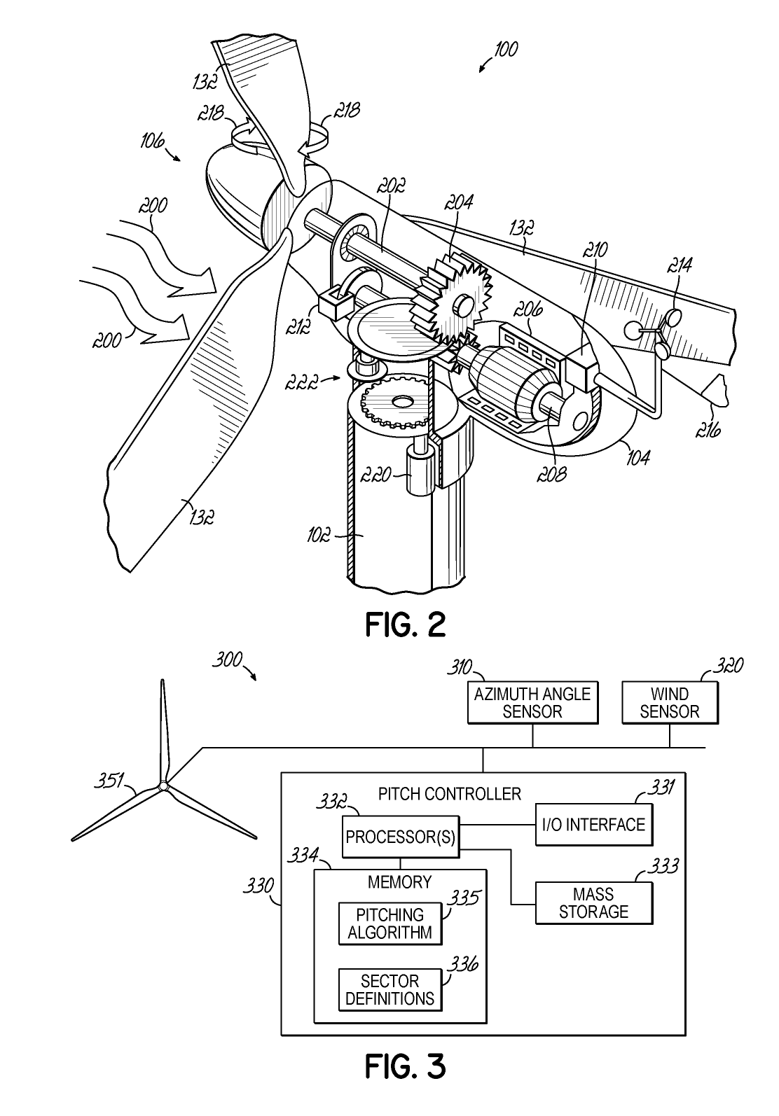

FIG. 2 illustrates a diagrammatic view of typical components internal to the nacelle 120 and tower 110 of a wind turbine generator 100. When the wind 200 pushes on the blades 132, the rotor 130 spins, thereby rotating a low-speed shaft 202. Gears in a gearbox 204 mechanically convert the low rotational speed of the low-speed shaft 202 into a relatively high rotational speed of a high-speed shaft 208 suitable for generating electricity using a generator 206. In an alternative embodiment, the gear box may be omitted, and a single shaft, e.g., the shaft 202 may be directly coupled with the generator 206.

A controller 210 may sense the rotational speed of one or both of the shafts 202, 208. If the controller decides that the shaft(s) are rotating too fast, the controller may signal a braking system 212 to slow the rotation of the shafts, which slows the rotation of the rotor 106, in turn. The braking system 212 may prevent damage to the components of the wind turbine generator 100. The controller 210 may also receive inputs from an anemometer 214 (providing wind speed) and/or a wind vane 216 (providing wind direction). Based on information received, the controller 210 may send a control signal to one or more of the blades 108 in an effort to adjust the pitch 218 of the blades. By adjusting the pitch 218 of the blades with respect to the wind direction, the rotational speed of the rotor (and therefore, the shafts 202, 208) may be increased or decreased. Based on the wind direction, for example, the controller 210 may send a control signal to an assembly comprising a yaw motor 220 and a yaw drive 222 to rotate the nacelle 104 with respect to the tower 102, such that the rotor 106 may be positioned to face more (or, in certain circumstances, less) upwind.

The generator 206 may be configured to generate a three phase alternating current based on one or more grid requirements. In one embodiment, the generator 206 may be a synchronous generator. Synchronous generators may be configured to operate at a constant speed, and may be directly connected to the grid. In some embodiments, the generator 206 may be a permanent magnet generator. In alternative embodiments, the generator 206 may be an asynchronous generator, also sometimes known as an induction generator. Induction generators may or may not be directly connected to the grid. For example, in some embodiments, the generator 206 may be coupled to the grid via one or more electrical devices configured to, for example, adjust current, voltage, and other electrical parameters to conform with one or more grid requirements. Exemplary electrical devices include, for example, inverters, converters, resistors, switches, transformers, and the like.

Embodiments of the invention are not limited to any particular type of generator or arrangement of the generator and one or more electrical devices associated with the generator in relation to the electrical grid. Any suitable type of generator including (but not limited to) induction generators, permanent magnet generators, synchronous generators, or the like, configured to generate electricity according to grid requirements falls within the purview of the invention.

Conventional wind turbines measure wind speed and direction using for example, a wind sensor or a LIDAR device and determine an amount of energy that can be safely captured from the wind. Based on the amount of energy that is desired to be produced, a wind turbine controller may determine a collective pitch angle of the blades of the wind turbine to facilitate capture of the desired amount of energy. This approach assumes that the wind characteristics, e.g., wind speed, turbulence, etc., are uniform across the rotor plane. In other words, this approach is effective only when wind characteristics are uniform across the rotor plane.

However, as wind turbines continue to proliferate the energy generation market, many wind turbine manufacturers continue to increase the size of their wind turbines. This is done because larger wind turbines with larger blades are able to capture more energy from the wind and generate a greater amount of power. As the swept area of a wind turbine increases, the probability of experiencing different wind speeds at different locations of the swept area also increases. For example, the wind below the nacelle position may be slower and more turbulent than the wind above the nacelle.

FIG. 3 illustrates an exemplary control system 300 of a wind turbine 351 according to an embodiment of the invention. As illustrated the control system 300 may include an azimuth angle sensor 310, a wind sensor 320 and a pitch controller 330. The azimuth angle sensor 310 may be configured to determine a position of each blade of the wind turbine 251 in the rotor plane. The wind sensor 320 may be any device configured to determine one or more properties of wind, e.g., wind speed, wind direction, turbulence, and the like. For example, the wind sensor may represent any one of the sensor 123 and LIDAR device 180 illustrated in FIG. 1. The wind sensor 320 may measure the wind characteristics at the rotor or at a location ahead of the rotor, or both.

The pitch controller 330 can be implemented using one or more processors 332 selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog and/or digital) based on operational instructions that are stored in a memory 334.

Memory 334 may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing digital information.

Mass storage device 333 may be a single mass storage device or a plurality of mass storage devices including but not limited to hard drives, optical drives, tape drives, non-volatile solid state devices and/or any other device capable of storing digital information. An Input/Output (I/O) interface 331 may employ a suitable communication protocol for communicating with the wind turbine 331 and sensors 310 and 320.

Processor 332 operates under the control of an operating system, and executes or otherwise relies upon computer program code embodied in various computer software applications, components, programs, objects, modules, data structures, etc. to read data from and write instructions to one or more wind turbines of wind farm 310 through I/O interface 331, whether implemented as part of the operating system or as a specific application.

In one embodiment of the invention, the pitch controller 330 may be configured to individually pitch each blade of the wind turbine 351 based on a location of the blade in the rotor plane. The pitching of each blade may be controlled by a pitching algorithm 335 illustrated in memory 334 of FIG. 3.

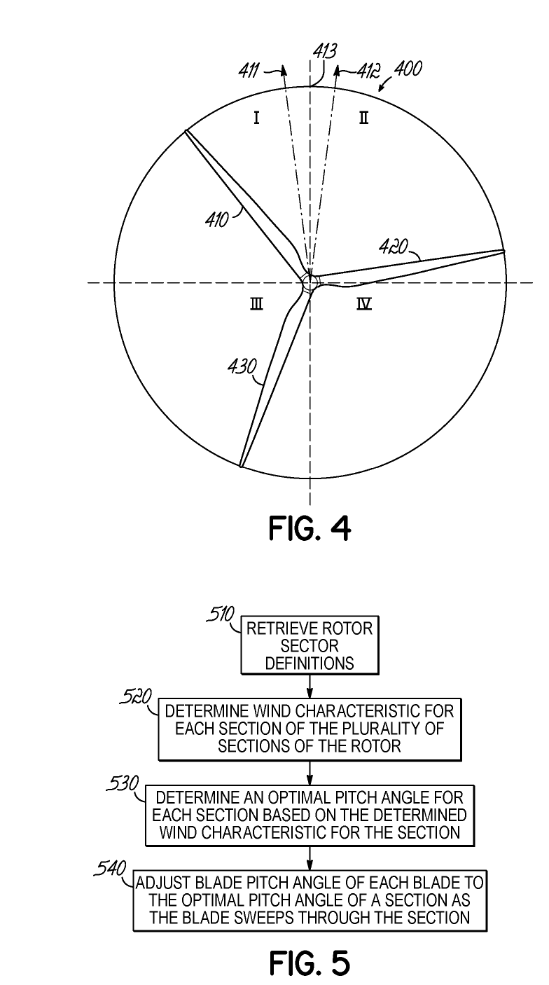

In one embodiment of the invention, the rotor plane of a wind turbine may be divided into a predefined number of sections which may be defined in the sector definitions 336 of memory 334. FIG. 4 illustrates exemplary sector definitions according to an embodiment of the invention. Specifically, a rotor plane 400 of a wind turbine is shown comprising blades 410, 420, and 430. As illustrated, the rotor plane of the wind turbine may be divided into a plurality of predefined sectors. For example, the sectors I, II, III, and IV are illustrated in FIG. 3. In alternative embodiments, any number of sectors may be defined. For example, in a particular embodiment, the rotor plane may be divided into 12 different sectors.

In one embodiment of the invention, the controller 330 may be configured to determine one or more characteristics of wind associated with a particular sector. For example, a LIDAR device 180 may be used to determine the speed of wind heading towards sector IV of the wind turbine rotor plane. Based on the determined wind characteristics, the controller 330 may determine an optimal pitch angle configured to generate the maximum amount of power from sector IV. Accordingly, when each blade of the wind turbine sweeps through sector IV, the optimal pitch angle may be used to derive the maximum amount of power that is reasonably possible. Similar optimal pitch angles may be determined for each sector in the rotor plane so that maximum power can be captured by the blades while passing through the respective sectors.

By dividing the rotor plane into a predefined number of sectors and pitching each blade to an optimal pitch angle as it passed through a respective sector, embodiments of the invention facilitate maximizing energy capture from the wind when different wind conditions may be experienced in different parts of the rotor plane. For the purposes of adjusting the blade pitch angle, the specific location of each blade relative to the predefined sectors may be determined by an azimuth sensor, e.g., the azimuth sensor 310 illustrated in FIG. 3.

While using a LIDAR device to determine characteristics of the wind for a particular sector is described hereinabove, in alternative embodiments, any other means for determining wind characteristics may be used. For example, in one embodiment, the blade load sensor readings may be used to determine an amount of bending of a blade while passing through a given sector. The bending of the blade may be correlated to a characteristic of the wind, for example, the wind speed. Based on the determined wind speed, an optimal pitch angle for the sector may be determined.

In one embodiment of the invention, the controller 330 may be configured to determine an estimated wind speed and a collective pitch angle for the blades of the wind turbine. Thereafter, the controller 330 may determine specific wind conditions for each of a plurality of sectors of the wind turbine rotor plane. Based on the determined wind conditions, the controller may determine, for each sector, an offset value to offset the collective pitch angle of the blades.

FIG. 5 is a flow diagram of exemplary operations performed by the pitch controller 330 while executing the pitching algorithm 335, according to an embodiment of the invention. The operations may begin in step 510 by retrieving rotor sector definitions dividing the rotor plane into a plurality of sections. In step 520, the controller may determine a wind characteristic associated with each section of the plurality of sections. In step 530, the controller may determine an optimal pitch angle for each section based on the determined wind characteristic for the section. In step 540, the controller may adjust the blade pitch angle of each blade to the optimal pitch angle as the blade sweeps through the section.

In one embodiment of the invention, the controller 330 may transition a blade pitch angle from a first optimal pitch angle to a second optimal pitch angle at or near a boundary area between two sectors. For example, referring back to FIG. 4, a transition zone is illustrated between the lines 411 and 412. In one embodiment of the invention, assuming that the rotor moves clockwise, the controller 330 may begin adjusting the pitch angle of a blade from the optimal pitch angle associated with sector I to the optimal pitch angle associated with sector II in the transition zone. Whether a blade has entered a transition zone may be determined by measurements received from an azimuth sensor, e.g., the azimuth sensor 310 of FIG. 3. Alternatively, the controller 330 may simply begin changing the pitch angle of a blade to the optimal pitch angle of a sector as soon as the blade enters the sector.

The transition of the pitch angle of a blade from an optimal pitch angle in a first sector to an optimal pitch angle in a second sector may be performed in a smooth and continuous manner. For example, referring to the transition zone in FIG. 4, the pitch angle may be smoothly changed from the optimal pitch angle of sector I to the optimal pitch angle of sector II in the transition zone, in one embodiment. In alternative embodiments, the pitch angle may be changed in a stepwise manner. For example, the pitch angle may be periodically adjusted by a predefined amount every predefined period of time until a desired optimal pitch angle is reached.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A method for improving power production of a wind turbine comprising:
dividing a rotor plane into a plurality of sections;
for each section, determining a characteristic of wind associated with the section;
for each section, determining an optimal pitch angle based on the determined characteristic of wind of the section; and
adjusting a pitch angle of a blade of the wind turbine to the optimal pitch angle of each section as the blade sweeps through the section.

2. The method of claim 1, wherein the characteristic of wind that is determined is wind speed.

3. The method of claim 1, wherein the optimal pitch angle comprises a combination of a collective pitch angle for the wind turbine and an offset value associated with the section.

4. The method of claim 1, wherein determining the characteristic of the wind comprises receiving a measurement from a Light Detection and Ranging device.

5. The method of claim 1, wherein determining the characteristic of the wind comprises receiving a measurement from a blade load sensor.

6. A pitch controller of a wind turbine, wherein the pitch controller is configured to:
divide a rotor plane into a plurality of sections;
for each section, determine a characteristic of wind associated with the section;
for each section, determine an optimal pitch angle based on the determined characteristic of wind of the section; and
adjust a pitch angle of a blade of the wind turbine to the optimal pitch angle of each section as the blade sweeps through the section.

7. The pitch controller of claim 6, wherein the characteristic of wind that is determined is wind speed.

8. The pitch controller of claim 6, wherein the optimal pitch angle comprises a combination of a collective pitch angle for the wind turbine and an offset value associated with the section.

9. The pitch controller of claim 6, wherein determining the characteristic of the wind comprises receiving a measurement from a Light Detection and Ranging device.

10. The pitch controller of claim 6, wherein determining the characteristic of the wind comprises receiving a measurement from a blade load sensor.

11. A wind turbine comprising:
a rotor, wherein the rotor plane is divided into a plurality of predefined sections;
an azimuth angle sensor configured to determine a position of each blade in the rotor plane; and
a pitch controller configured to:
for each section, determine a characteristic of wind associated with the section;
for each section, determine an optimal pitch angle based on the determined characteristic of wind of the section; and
adjust a pitch angle of a blade of the wind turbine to the optimal pitch angle of each section as the blade sweeps through the section.

12. The wind turbine of claim 11, wherein the characteristic of wind that is determined is wind speed.

13. The wind turbine of claim 11, wherein the optimal pitch angle comprises a combination of a collective pitch angle for the wind turbine and an offset value associated with the section.

14. The wind turbine of claim 11, wherein the pitch controller is configured to determine the characteristic of the wind by one of:
receiving a measurement from a Light Detection and Ranging device; and
receiving a measurement from a blade load sensor.

15. The wind turbine of claim 11, wherein the pitch controller is configured to:
determine whether a blade of the wind turbine has entered a transition zone associated with a first section and a second section; and
smoothly adjust the blade pitch angle from a first optimal blade pitch angle associated with the first section to a second optimal pitch angle associated with the second section as the blade sweeps through the transition zone.
